(19) United States
(12) Patent Application Publication
(10) Pub. No.: US 2006/0094494 A1
(43) Pub. Date: May 4, 2006

(54) Keno feature trigger

(75) Inventors: Terry O'Halloran, Paddington (AU); Peter Wilkins, Curl Curl (AU)

Correspondence Address: SACCO & ASSOCIATES, PA, P.O. BOX 30999, PALM BEACH GARDENS, FL, 33420-0999, US

(73) Assignee: Stargames Corporation Pty Limited, Milperra (AU)

(21) Appl. No.: 11/260,910

(22) Filed: Oct. 28, 2005

(30) Foreign Application Priority Data
Oct. 28, 2004 (AU) 2004906201

(51) Int. Cl. G06F 19/00

(52) U.S. Cl. 463/18

(57) ABSTRACT

A keno game is disclosed which incorporates a bonus feature. For each game, a predetermined condition is set to designate a specific ball, eg that the last ball drawn is number 9. This may be determined for al participants or individually for each participant, randomly or by selection. If the ball is drawn as defined, a bonus prize is paid.

### CROSS REFERENCE TO RELATED APPLICATIONS

This application claims benefit of Australian Patent Application Serial No. 2004906201 filed Oct. 28, 2004.

### FIELD OF THE INVENTION

The present invention relates to a method and apparatus for providing an added feature on a standard game of Keno.

### BACKGROUND OF THE INVENTION

Keno is a game that allows players to select numbers from a pre-determined range with prizes that escalate the more of the selected numbers are subsequently drawn.

The player chooses a set of numbers from a pre-determined range, how many are chosen in the set being determined by the player but within the limits of the rules, specified in the particular game being played. A further set of numbers are then randomly selected by operating means such as a machine, computer, or drawn out of a barrel.

The objective of the game is to choose as many matching numbers from those drawn as possible. The player wins a prize if a certain number out of the set of numbers the player chose were also selected in the further set of randomly drawn numbers. The value of the prize is dependant on how much is wagered per game, how many numbers were chosen by the player, and how many numbers matched in the second set.

There are specific rules for the game of Keno depending upon where it is played. For example, the rules will specify how many numbers the player is allowed to choose, and how many of these numbers are required in order to receive a prize, all of which can vary according to the way and place in which you are playing.

The game of Keno played under the South Australian Lotteries Commission uses 80 numbers, with 20 drawn for each game. Players can select between 1 and 10 numbers, also called “spots”, out of the 80, with the more spots chosen, the bigger the prize which can be won.

Keno can also be played on a slot machine, or online using a computer program, where each game is played individually rather than among a large number of people like in a casino or club for example.

To maintain the interest of players and to attract new players to the game, it is desirable to implement new features within the game. However, due to the reasonably fixed parameters and equal chance of each number being drawn, the introduction of new game features is made rather difficult. Further, the probability of winning the jackpot (or maximum prize) is very low which means people often do not continue to play.

It is an object of the present invention to provide at least one additional game feature within a standard game of Keno.

### SUMMARY OF THE INVENTION

According to a first aspect of the invention, there is provided a method for operating a Keno game, the method including the steps of;

Permitting each player to select a set of numbers {P} from a pre-determined integer range;

Determining a set of numbers {X} of a predetermined size from the pre-determined range;

Determining whether set {X} meets a predetermined trigger condition relating to one or more predetermined numbers N, and if so, triggering a bonus feature; and

Determining standard prizes and any bonus prizes.

According to another aspect, the present invention provides a machine for playing a keno game, said machine including display means, a player interface and processing means, said interface means permitting each player to select a set of numbers {P} from a pre-determined integer range; said processing means being operatively arranged to determine a set of numbers {X} of a predetermined size from said pre-determined range, and to determine whether set {X} meets a predetermined trigger condition relating to one or more predetermined numbers N, and if so, to trigger a bonus feature; and to further determine standard prizes according to the keno game and any bonus prizes.

The present invention accordingly allows Keno players to win further prizes by adding a bonus feature to the standard Keno game. It provides for variety in playing the game of Keno and encourages new players to play Keno by giving further incentives for winning.

The present invention also encompasses apparatus adapted to carry out the method, and a software product operatively adapted to carry out the method.

Further features and aspects of this invention will become apparent from the following specific non-limiting example of one preferred embodiment given in relation to the accompanying drawings.

### BRIEF DESCRIPTION OF THE DRAWINGS

An illustrative embodiment of the present invention will be described with reference to the accompanying figures, in which:

FIG. 1 is a flowchart illustrating one implementation of the inventive method;

FIG. 2 is a flowchart illustrating one more particular implementation of the inventive method;

FIG. 3 is a sample screen display for one implementation of the present invention.

### DESCRIPTION OF PREFERRED EMBODIMENT

The present invention will be described with reference to a particular implementation. It will be appreciated that game designers could implement the present invention in many different ways to satisfy the demands of their particular game and systems. Numerals relating to references to the figures are given in underlined font, to distinguish from other numerals used to describe features of the particular implementations.

The present invention provides for a bonus feature on a standard game of Keno.

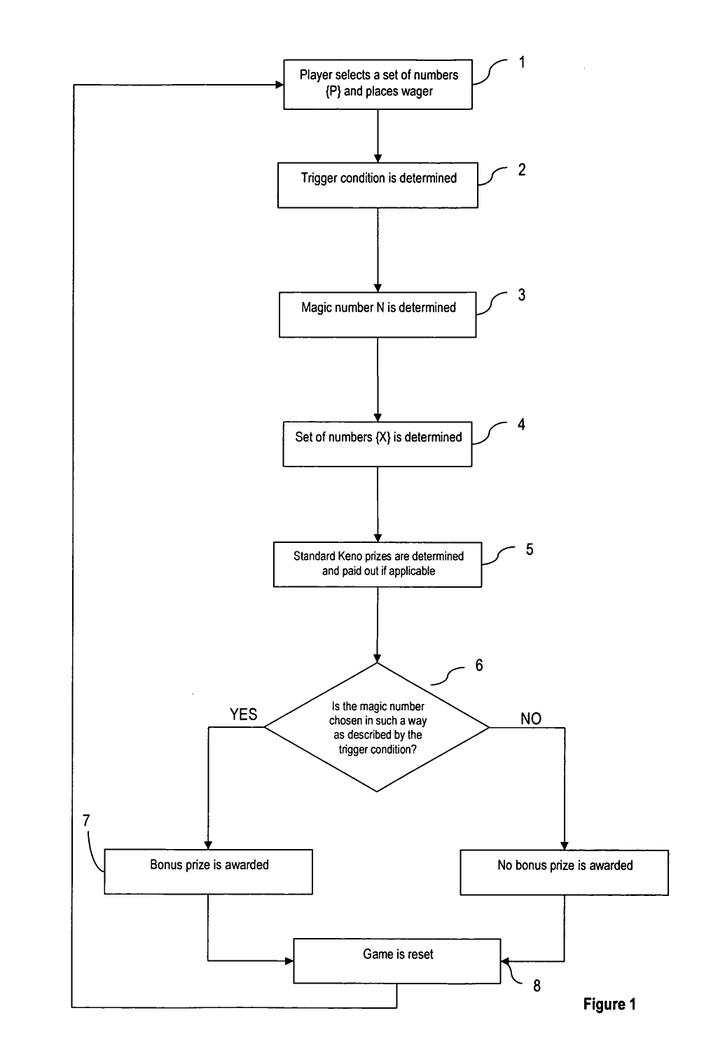

FIG. 1 shows a flowchart of one general implementation of the inventive method of the present invention. The player selects their numbers according to the rules of that particular game of Keno and places their wager 1. The method for determining how the bonus prize will be paid out, known as the trigger condition, is determined 2. This may be determined at random by the operating means, or by any other suitable method.

The operating means in this sense is simply the particular system in which the game of Keno is played. For example, the operating means could be a computer system with the particular software being adapted to choose the trigger condition. Another example of the operating means may be a physical process, such as a person, who chooses the trigger condition from a list. In the case of the operating means being a slot machine, the trigger condition could be unique to a particular slot machine so that the player could be aware of the trigger condition for that machine prior to the commencement of the game.

The particular trigger condition that is part of the bonus game is not limited to any particular type or form of condition. As an example, the trigger condition may be that a pre-determined number N, hereinafter called the “magic number”, is the nth number drawn out in the standard Keno game, so that if n=15, the bonus prize will be won if the magic number N is the 15^{th} number drawn by the operating means.

Alternatively, the condition could simply be that some or all numbers in a range or set are drawn, in any one or more specified locations in the drawn numbers. It will be understood that the condition is preferably somewhat commensurate with the prize: for example, a less valuable prize could be triggered by a more probable set of outcomes than a more valuable prize.

In the implementation shown in FIG. 1, the next step is that the magic number N is determined 3. This may be chosen at random, or by any other way according to the particular rules of the game. For example, in a slot machine, there may be a computer program set to choose the magic number randomly from the pre-determined set of numbers. Alternatively, the magic number could be a fixed number for the venue in which the game is being played.

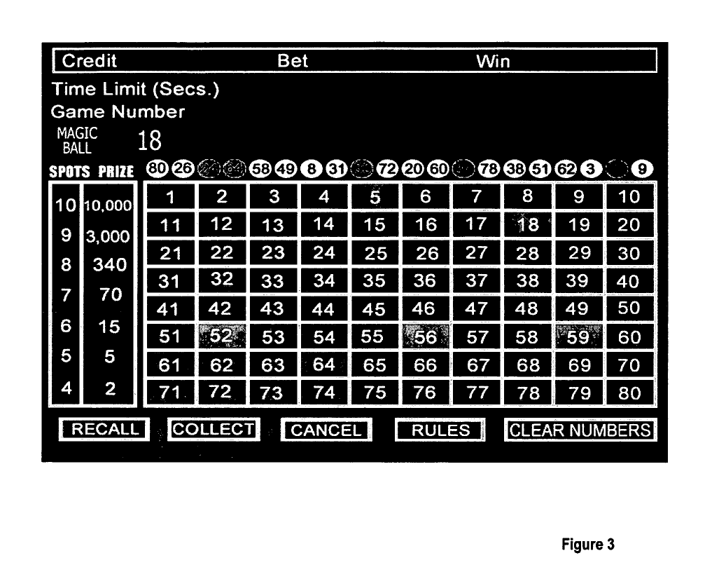

Both the magic number and the trigger condition should be displayed to the players prior to the commencement of the standard game in order to maintain a measure of fairness. This could be displayed on a computer screen, on posters around the venue if the magic number is a fixed number for that venue, or on the player's betting slip. Where the game is adapted to a slot machine, it could be displayed throughout the game on a display such as that in FIG. 3. In the screen display in FIG. 3, the “magic ball” (identical to “magic number” referred to elsewhere in this description) is displayed on the screen throughout the time the game is being played. The magic ball in this implementation is preferably randomly selected for each player for each game, prior to the game being played.

The standard game of Keno is then played, with the operating means drawing a set of numbers {X} from the pre-determined range 4. The exact number in both the range and the drawn set varies according to the particular rules of Keno at the place where the game is being played, and as such the present invention has not been limited to a certain number.

The standard prizes are then determined and paid out (if applicable) according to the particular rules of Keno 5. The particular determination and value of the particular prizes are not limited to those described, and may be any prize deemed appropriate and financially viable by the operator. Winning prizes in the standard game of Keno is determined by matching the numbers chosen by the player {P} to the random numbers {X} drawn by the operating means. The value of the prize won is determined by how many numbers are matched by the player; how many numbers were initially chosen by the player; and the amount the player wagered.

The determination of any bonus prize is then determined according to the trigger condition 6. For example, if the magic number N satisfies both the criteria, (1) that the value of the number was actually drawn out by the operating means in the random number selection, and (2) that it was drawn out according to the pre-determined trigger condition, a bonus prize is won 7. The bonus prize is not limited to any particular prize. As an example, the bonus prize may be cash, free games of Keno, free drinks, free packet of chips. It could alternatively be loyalty points or the like from a casino, club or more broadly based scheme. The bonus prize is not dependant on the amount of the standard prize won, however, such a dependency may provide a suitable embodiment of the present invention.

Once any bonus prizes are paid out, the game is reset 8 and the game cycle recommences.

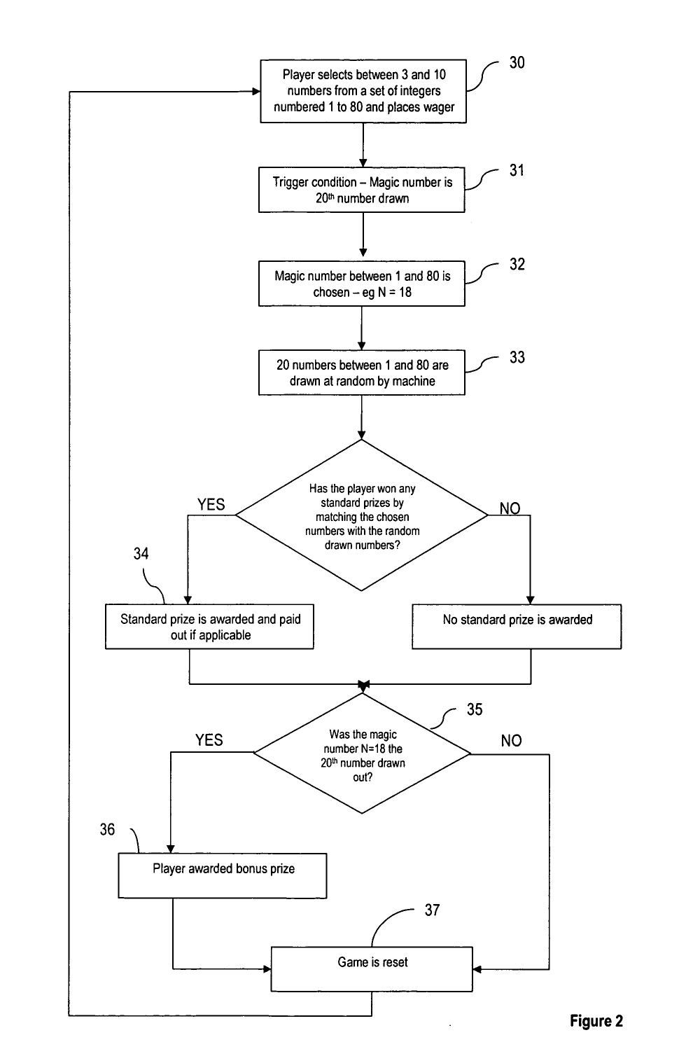

FIG. 2 shows a more particular implementation of the inventive method. In this particular implementation, the player selects between 3 and 10 numbers from a set of numbers labelled 1 to 80 and places their wager 30. All numbers have an equal chance of being drawn.

The trigger condition is determined, which in this case is that the magic number is the 20^{th} number drawn 31. The trigger condition, however, is random and may change for each game played.

The magic number is chosen by the machine at random 32 from amongst the set 1 to 80. In the particular embodiment shown in FIG. 2, the magic number chosen is the number 18.

The standard game of Keno is then played according to the particular rules of the game being played 33. In the embodiment shown, 20 numbers are randomly drawn from the set of 1 to 80. Once the 20 numbers are drawn, the numbers the player chose are matched to the 20 numbers drawn by the machine. A player wins a prize if a certain number of the player-chosen numbers are matched to any of the 20 numbers drawn from the machine.

The value and determination of the particular prize won differs from game to game. Table 1 below shows an example of the prize range for a game with available numbers 1 to 80 and 20 balls are chosen in any one game, where players can choose between 3 and 10 numbers.

TABLE 1
An example of values of standard prizes which may be paid out in the game of Keno

| Hits | Spot 3 | Spot 4 | Spot 5 | Spot 6 | Spot 7 | Spot 8 | Spot 9 | Spot 10 |
|---|---|---|---|---|---|---|---|---|
| 0 | | | | | | | | $2.00 |
| 1 | | | | | | | | |
| 2 | $4.00 | $2.00 | | | | | | |
| 3 | $28.00 | $9.00 | $7.00 | $2.00 | | | | |
| 4 | | $40.00 | $20.00 | $7.00 | $5.00 | $2.00 | | |
| 5 | | | $175.00 | $135.00 | $50.00 | $10.00 | $7.00 | $5.00 |
| 6 | | | | $500.00 | $175.00 | $200.00 | $75.00 | $20.00 |
| 7 | | | | | $5,000.00 | $650.00 | $400.00 | $150.00 |
| 8 | | | | | | $5,000.00 | $1,400.00 | $750.00 |
| 9 | | | | | | | $5,000.00 | $3,000.00 |
| 10 | | | | | | | | $5,000.00 |

According to the presently described embodiment, once the standard prizes have been determined and paid out 34, any bonus prize is determined 35. In the present embodiment, the bonus prize is awarded if the number 18 was the 20^{th} number chosen by the machine. If this condition is true, the player wins a bonus prize 36. If the condition is not true, the game is reset and the game cycle recommences 37.

The present invention is suited to many types of operating means. FIG. 3 shows the screen display for an embodiment of the present invention adapted to a slot machine. In this embodiment, the player selects between 3 and 10 numbers from 1 to 80. In FIG. 3, the player has selected 10 numbers, those being the numbers 5, 18, 24, 30, 32, 37, 52, 56, 59, 64. The amount of the wager is not shown on the screen in FIG. 3, however, the prize value has been calculated to show the player how much they can win depending on how many numbers they match (which is dependent on the wager) 40.

The magic number has been chosen, which in this particular embodiment is called the “magic ball” and is shown at the upper left hand side of the screen 41 as the number 18.

In FIG. 3, the game has already been played, with the 20 numbers drawn being shown in the balls across the screen 42, being numbers 80, 26, . . . , 32, 9.

The player has matched 5 numbers, those being 24, 30, 32, 37, 64. The standard prize of $5, according to the prize listing on the screen, will be paid out.

The particular trigger condition for this game is not shown on the screen display in FIG. 3. However, if the trigger condition for this game was that the magic ball (N=18) must be the 20^{th} number chosen, it is clear that no bonus prize would be awarded since the 20^{th} number chosen is shown on the screen in FIG. 3 to be the number 9. In this particular embodiment, the player would not be awarded the bonus prize.

The embodiment in FIG. 3 shows the player having chosen the number 18 in their set {P}, as well as the magic ball being the number 18. However, this is coincidental, and in order for the player to win the bonus prize, the player does not need to have chosen the value of the magic number in their set {P}. The bonus prize is unrelated to the numbers the player has chosen, and also unrelated to the amount of standard prize won by the player. However, these could both be suitable embodiments of the present invention.

Once any bonus prize is determined and paid out, the game cycle recommences.

Particular Embodiment Suited to a Slot Machine

It is envisioned that the Keno Feature Trigger game will be most preferably played on a slot machine. The following embodiment, with reference to FIG. 3, describes the preferred implementation of the game played on a slot machine.

The game will preferably utilise existing hardware with contingency made for a button panel, and a no button panel.

The regular Keno game will allow players to select between 3 and 10 numbers out of the numbers 1 to 80. The aim of the game is for the player to match as many numbers as possible as drawn by the machine. 20 balls will be drawn, and the more numbers that the player has chosen, the higher the standard prize won. Preferably there will be a dealer display screen which will show all the numbers as they are drawn, however it is also preferred that each ATS will also display the results.

Players will have between 15 and 40 seconds to select their numbers (operator selectable from 15 secs in 5 second increments). Once the time for the players to select their numbers has ended, the winning numbers will be drawn and displayed on the dealer display screen and each player's screen. On the player's screen, coloured number tiles and balls will indicate a number of options, as shown in table 2 below.

TABLE 2
Colour code for screen display once numbers drawn

| Colour ball/tile | Meaning |
|---|---|
| Red Ball | Number chosen by player |
| White Ball | Number not chosen by player |
| Green Tile | Number selected by player, but no result |
| Red Tile | Number selected by player and result drawn by dealer |
| Yellow Tile | Number drawn but not selected by player |

There will preferably be a number of buttons, both on screen and/or on a button panel, with differing functionality, as set out in tables 3 and 4 below.

TABLE 3
Functionality of on screen buttons

| | |
|---|---|
| Erase | Will erase all numbers selected |
| Collect | Calls attendant |
| Reserve | Reserves machine for 3 minutes |
| Cancel | Will cancel bet (remove chip from screen) |
| Recall | Will recall last set of numbers and bet value |
| Rules | Calls up Rules pages |
| Undo | Undoes last action (number selection or bet) |

TABLE 4
Functionality of button panel

| | |
|---|---|
| Erase | Will erase all numbers selected |
| Recall | Will recall last set of numbers and bet value |
| Random 10 | Randomly selects 10 numbers (no bet value included) |
| Collect | Calls attendant |
| Reserve | Reserves machine for 3 minutes |

It is preferred that the following denominations and betting chips required for each game setup will be included for the game configuration:
20c-20c/$1/$2/$5 (Maximum bet: $50)
50c-50c/$1/$2/$5
$1-$1/$2/$5/$10

There will preferably be 3 game variations included, with the return to player (RTP) being either 93%, 94% or 95%. The following tables show the prize/pay tables for standard prize payouts that would preferably be used for each return variation.

TABLE 5
Pay table based on 1 credit bet for 93% variation

| | 3- | 4- | 5- | 6- | 7- | 8- | 9- | 10- |
|---|---|---|---|---|---|---|---|---|
| Prizes | spot | spot | spot | spot | spot | spot | spot | spot |
| 0 | | | | | | | | 3 |
| 1 | | | | | | | | |
| 2 | 3 | 1 | | | | | | |
| 3 | 28 | 10 | 4 | 2 | | | | |
| 4 | | 42 | 20 | 7 | 3 | 2 | 1 | |
| 5 | | | 150 | 45 | 20 | 5 | 4 | 2 |
| 6 | | | | 250 | 120 | 40 | 15 | 10 |
| 7 | | | | | 750 | 240 | 65 | 25 |
| 8 | | | | | | 1000 | 400 | 100 |
| 9 | | | | | | | 1200 | 500 |
| 10 | | | | | | | | 1700 |

TABLE 6
Pay table based on 1 credit bet for 94% variation

| | 3- | 4- | 5- | 6- | 7- | 8- | 9- | 10- |
|---|---|---|---|---|---|---|---|---|
| Prizes | spot | spot | spot | spot | spot | spot | spot | spot |
| 0 | | | | | | | | 3 |
| 1 | | | | | | | | |
| 2 | 4 | 1 | | | | | | |
| 3 | 20 | 10 | 4 | 2 | | | | |
| 4 | | 44 | 20 | 7 | 3 | 2 | 1 | |
| 5 | | | 155 | 46 | 20 | 5 | 4 | 2 |
| 6 | | | | 250 | 120 | 40 | 15 | 10 |
| 7 | | | | | 770 | 250 | 65 | 26 |
| 8 | | | | | | 1000 | 410 | 100 |
| 9 | | | | | | | 1200 | 500 |
| 10 | | | | | | | | 1700 |

TABLE 7
Pay table based on 1 credit bet for 95% variation

| | 3- | 4- | 5- | 6- | 7- | 8- | 9- | 10- |
|---|---|---|---|---|---|---|---|---|
| Prizes | spot | spot | spot | spot | spot | spot | spot | spot |
| 0 | | | | | | | | 3 |
| 1 | | | | | | | | |
| 2 | 3 | 1 | | | | | | |
| 3 | 29 | 10 | 4 | 2 | | | | |
| 4 | | 46 | 20 | 7 | 3 | 2 | 1 | |
| 5 | | | 160 | 48 | 20 | 5 | 4 | 2 |
| 6 | | | | 250 | 120 | 42 | 16 | 10 |
| 7 | | | | | 800 | 250 | 67 | 29 |
| 8 | | | | | | 1000 | 400 | 100 |
| 9 | | | | | | | 1200 | 500 |
| 10 | | | | | | | | 1700 |

Preferably there will be options for the timing of the games between 15 and 40 seconds in 5 second increments. This will be based on a 5 second “Place your bets” animation, a 5 second “No more bets” animation, a 5 second filler and a 10 second filler. The other main timing reference will be 0.5 secs between each number drawn.

The player may only enter numbers onto the “scorecard” 43 once a bet value has been placed inside the bet space 44 provided. Once this has occurred, the player can start to enter their chosen numbers. The paytable 40 will start to be updated once the minimum number of “spots” has been entered. All reference to prizes in the paytable 40 will be multiplied by the number of credits bet.

Accompanying the standard game of Keno, will be the additional Keno Feature Trigger game. In the preferred embodiment, this bonus game will provide for free games to be won by players of the main Keno game.

The bonus game will be triggered by a “Magic Ball”. Practically, an area 41 on the ATS will be nominated as the “Magic Ball” area. At the completion of the standard Keno game countdown, each player will be given a number between 1 and 80 that is their “Magic Ball”. Players may have the same as each other as it is chosen independently of each player. In this embodiment, the trigger condition is that the last ball is chosen. Therefore, if the last ball chosen 46 by the DDD (Dealer Display Device) is the same as the player's number 41, the player wins a prize, preferably 3 free games. These free games will preferably be played at the same stake and with the same numbers that were being played when the feature was triggered. Preferably, no “Magic Ball” numbers appear during the free games (ie preferably the free games will only have a standard game component, and no bonus game). The probability of a player winning the bonus feature will be 1 in 80.

During the free games, any number that appears is held for any free games that may be remaining. In the instance a number appears that has appeared in a previous free game, then the ball is treated as if it has just hit, ie no different. This will result in the possibility that prizes recur over the 5 games. In the unlikely event a player gets all 10 numbers on the first free game, they will get paid 5,000 credits for each free game thereafter.

All free game wins will be accumulated in the win meter like a slot machine, and each win is independent so that the maximum prize can be won 3 times in a row.

Probabilities and Returns to Players

To make the game fair for players, it is preferred the total return to player is roughly the same for each multiple spot combination available (3 to 10). The total game return to player (RTP) is made up of the base (standard) game and the bonus game. The difference between these components differs however the more spots the person plays. For example, in the 95% variation, the 3-spot base game returns 13.621% while the bonus game returns 81.865% of the total of 95%, while the 10-spot game returns 41.854% in the base game and 53.690% in the bonus game. This data is shown in Table 8 below.

TABLE 8
Player Return Summary for 95% variation

| | 3-spot | 4-spot | 5-spot | 6-spot | 7-spot | 8-spot | 9-spot | 10-spot |
|---|---|---|---|---|---|---|---|---|
| Base RTP | 81.865 | 78.603 | 68.077 | 64.024 | 43.671 | 39.838 | 38.957 | 41.854 |
| (%) | | | | | | | | |
| Bonus RTP | 13.621 | 16.435 | 27.115 | 31.308 | 51.378 | 55.509 | 56.280 | 53.690 |
| (%) | | | | | | | | |
| Total RTP | 95.486 | 95.038 | 95.193 | 95.332 | 95.049 | 95.347 | 95.237 | 95.544 |

It will be understood that many variations and additions are possible to implement the present invention but still falling within the broad scope of the present invention.

1. A method for operating a Keno game, the method including the steps of:
permitting each player to select a set of numbers {P} from a pre-determined integer range;
determining a set of numbers {X} of a predetermined size from the pre-determined range;
determining whether set {X} meets a predetermined trigger condition relating to one or more predetermined numbers N, and if so, triggering a bonus feature; and
determining standard prizes and any bonus prizes.

2. A method according to claim 1, wherein the or each number N is selected and displayed to players prior to determining set {X}.

3. A method according to claim 2, wherein the or each number N is selected by a random or pseudo-random process.

4. A method according to claim 3, wherein the trigger condition is that a single number N appears in set {X}.

5. A method according to claim 3, wherein order of drawing of the numbers in set {X} is determined and displayed, and the trigger condition is that a single number N appears in a specific draw position.

6. A method according to claim 1, wherein the set {X} may be determined by a slot machine, computer, mechanical device, human interaction or any other means.

7. A method according to claim 2, wherein the selection of the or each number N, is independent from player selections and independent from any previous action.

8. A method according to claim 1, wherein the bonus prize is unrelated to the amount of any standard prize won by the player.

9. A method according to claim 8, wherein the bonus prize is selected from the set including free games, money, goods, loyalty points and credits.

10. A machine for playing a keno game, aid machine including display means, a player interface and processing means, said interface means permitting each player to select a set of numbers {P} from a pre-determined integer range; said processing means being operatively arranged to determine a set of numbers {X} of a predetermined size from said pre-determined range, and to determine whether set {X} meets a predetermined trigger condition relating to one or more predetermined numbers N, and if so, to trigger a bonus feature; and to further determine standard prizes according to the keno game and any bonus prizes.

11. A machine according to claim 10, wherein a plurality of terminals are provided, each having display means and interface means, and being connected to a central processing system which determines the game outcomes.

12. A machine according to claim 10, wherein the or each number N is selected and displayed to players prior to determining set {X}.

13. A machine according to claim 12, wherein the or each number N is selected by a random or pseudo-random process.

14. A machine according to claim 13, wherein the trigger condition is that a single number N appears in set {X}.

15. A machine according to claim 13 wherein the order of drawing of the numbers in set {X} is determined and displayed, and the trigger condition is that a single number N appears in a specific draw position.

16. A machine according to claim 12, wherein the selection of the or each number N is independent from player selections and independent from any previous action.

17. A machine according to claim 10, wherein the bonus prize is unrelated to the amount of any standard prize won by the player.

18. A method according to claim 17, wherein the bonus prize is selected from the set including free games, money, goods, loyalty points and credits.
